(19) United States
(12) Patent Application Publication
(10) Pub. No.: US 2013/0298731 A1
(43) Pub. Date: Nov. 14, 2013

(54) METHOD FOR EFFICIENT EXTRACTION OF GOLD FROM GOLD ORES UTILIZING MACRO QUANTUM RESONANCE EFFECT

(71) Applicants: Qingwen Zhang, Washington, DC (US); Jingying Li, Washington, DC (US); Qingxin Zhang, Tianjin (CN); Yi Zhang, Tianjin (CN); Guangyao Zhang, Tainjin (CN); Tao Liu, Tianjin (CN); Ming Bai, Tianjin (CN)

(72) Inventors: Qingwen Zhang, Washington, DC (US); Jingying Li, Washington, DC (US); Qingxin Zhang, Tianjin (CN); Yi Zhang, Tianjin (CN); Guangyao Zhang, Tainjin (CN); Tao Liu, Tianjin (CN); Ming Bai, Tianjin (CN)

(21) Appl. No.: 13/466,438

(22) Filed: May 8, 2012

(51) Int. Cl. B22F 9/04; H01F 5/00; B82Y 99/00

(52) U.S. Cl. 75/345; 335/299; 977/932

(57) ABSTRACT

Gold ores are processed to obtain a mixture comprising gold particles and other particles, such as quartz particles. The mixture then passes through a location near a quantum resonance driver. The quantum resonance driver generates a macro quantum resonance effect that causes the gold particles to move away from the driver so that gold particles are separated from the mixture.

### TECHNICAL FIELD

The present disclosure relates to methods for extracting gold from gold ores. More particularly, the present disclosure relates to separating elemental gold from gold ores using macro quantum resonance effects.

### RELATED ART

The most common method for commercial production of gold is to extract gold from gold-containing ores (i.e., gold ores) by leaching, for example, using a cyanide solution. Elemental gold is first dissolved in the chemical solution then recovered from the solution by adsorption or precipitation. Such a method takes many steps and involves highly toxic chemicals, which is costly and harmful to the environment. Therefore, there is a need to find an energy efficient and environmentally friendly way to extract gold from gold ores.

### SUMMARY

In one embodiment, a method for separating gold from gold ores involves processing gold ores to obtain a mixture comprising gold particles and other particles, such as quartz particles. The mixture then passes through a location close to a quantum resonance driver. The quantum resonance driver generates a macro quantum resonance effect that causes the gold particles to move away from the driver so that gold particles are separated from the mixture.

In another embodiment, the quantum resonance driver comprises a coil of NbTi wire. The diameter of the wire ranges from 0.5 mm to 0.8 mm.

In a further embodiment, the quantum resonance driver operates at a frequency ranging from 10⁴ Hz to 10⁹ Hz. The quantum resonance driver generates a macro quantum resonance effect, which repels the gold particles away from the quantum resonance driver therefore separating gold particles from the mixture.

### BRIEF DESCRIPTION OF THE DRAWINGS

The teachings of the present invention can be readily understood by considering the following detailed description in conjunction with the accompanying drawings.

FIG. 1 illustrates a process for separating gold from gold ores of the present disclosure.

FIG. 2 illustrates an embodiment for separating gold particles from gold ore particles using a quantum resonance driver.

### DETAILED DESCRIPTION

Reference will now be made in detail to embodiments of the present disclosure, examples of which are illustrated in the accompanying drawings. It is noted that wherever practicable, similar or like reference numbers may be used in the drawings and may indicate similar or like elements.

The drawings depict embodiments of the present disclosure for purposes of illustration only. One skilled in the art would readily recognize from the following description that alternative embodiments exist without departing from the general principles of the present disclosure.

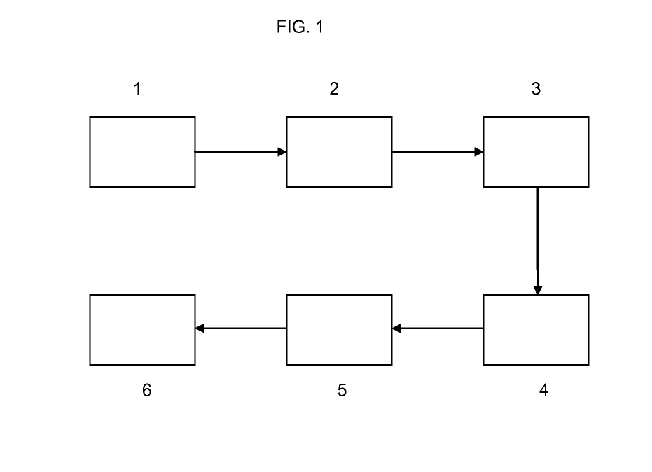

FIG. 1 is a schematic diagram showing a process for extracting gold. Step 1 is a step in which gold ores are crushed in an ore crusher into granulates of 30 mm to 50 mm in size. Step 2 is a step in which granulates of gold ores from Step 1 are dried in a dryer to reduce its water content to less than 2% in weight. In Step 3 the dried granulates of gold ores are charged into a high pressure grinder and grinded into fine particles of 200 mesh to 300 mesh in size. Step 4 involves removing metal impurities (e.g., iron) from fine particles obtained in Step 3 using a magnetic separator, for example, operating at a magnetic induction from 1000 gauss to 2000 gauss. In Step 5, fine particles from Step 4 is processed in a high voltage electrostatic separator. The electrostatic separator operates at a relatively high voltage, e.g., at 60,000 V. It concentrates gold in the ore particles by separating ore particles that respond differently from gold particles in an electric field. The concentration ratio can be 10 or higher. In Step 6 the gold-enriched ore particles from Step 5 is treated using a quantum resonance driver. The quantum resonance driver comprises a coil of NbTi wire (e.g., OD at 0.5 mm-0.8 mm) and operates at a frequency from 10⁴ Hz to 10⁹ Hz.

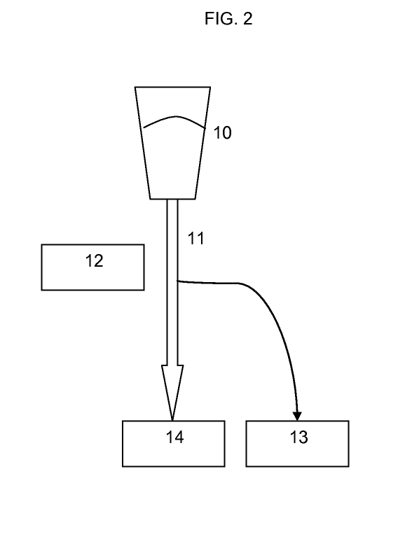

FIG. 2 is a schematic representation of an embodiment of the process in Step 6. The ore particles from Step 5 is charged into a hopper (10). A trickle of particles (11) are released from the hopper by gravitation. The quantum resonance driver (12) is placed close to the trickle of particles (11) without coming into contact with the particles. During operation, the gold particles are moved further away from the quantum resonance driver (12) due to the macro quantum resonance effect on the gold particles, while the rest of the ore particles (e.g., quartz particles) do not respond to the macro quantum resonance effect and are not moved. Consequently, the gold particles fall into a first collector (13) while the rest of the ore particles fall under gravity into a second collector (14). The ore particles collected in the second collector can be used to make other useful materials such as panels.

### EXAMPLE 1

Gold ores that contained about 10 grams gold per ton was crushed and grinded into particles of about 200 mesh in size. The particles were then dried to have a moisture content of about 1.6 wt %. The dry particles were treated in a magnetic separator having a magnetic induction of 2000 gauss to remove impurities and then processed in a high voltage electrostatic separator. The resulting ore particles contained about 100 grams of gold per ton of ore particles. The gold-enriched ore particles were then treated using a quantum resonance driver operating at 10⁶ Hz to separate gold particles from the rest of the ore particles (mainly quartz particles). The rate of recovery of gold was about 98%. The purity of the gold thus obtained was about 99%.

Embodiments of the present disclosure have been described in detail. Other embodiments will become apparent to those skilled in the art from consideration and practice of the present disclosure. Accordingly, it is intended that the specification and the drawings be considered as exemplary and explanatory only, with the true scope of the present disclosure being set forth in the following claims.

What is claimed is:

1. A method for separating gold from gold ores, comprising:
processing gold ores to obtain a mixture comprising gold particles; and
passing the mixture in a vicinity of a quantum resonance driver so that gold particles are separated from the mixture.

2. The method of claim 1, wherein the quantum resonance driver comprises a coil of NbTi wire.

3. The method of claim 2, wherein the diameter of the NbTi wire ranges from 0.5 mm to 0.8 mm.

4. The method of claim 1, wherein the quantum resonance driver operates at a frequency ranging from 10⁴ Hz to 10⁹ Hz.

5. The method of claim 1, wherein in the passing step the quantum resonance driver generates a macro quantum resonance effect that causes the gold particles to move away from the quantum resonance driver.

6. The method of claim 1, wherein the processing step further comprising:
crushing the gold ores into granulates of 30 mm to 50 mm in size;
drying the granulates so that the moisture content of the granulates is less than about 2% by weight; and
grinding the granulates into particles of 200 mesh to 300 mesh in size.

7. The method of claim 6, further comprising processing the particles in an electrostatic separator.

8. The method of claim 7, further comprising processing the particles in a magnetic separator.

9. A quantum resonance driver, comprising a coil of NbTi wire.

10. The quantum resonance driver of claim 9, wherein the NbTi wire has a diameter ranging from 0.5 mm to 0.8 mm.

11. The quantum resonance driver of claim 9, wherein the driver operates at a frequency ranging from 10⁴ Hz to 10⁹ Hz.

12. The quantum resonance driver of claim 9, which generates a macro quantum effect that causes a gold particle to move.
